(19) United States
(12) Patent Application Publication
(10) Pub. No.: US 2015/0081306 A1
(43) Pub. Date: Mar. 19, 2015

(54) PROSODY EDITING DEVICE AND METHOD AND COMPUTER PROGRAM PRODUCT

(71) Applicant: Kabushiki Kaisha Toshiba, Tokyo (JP)

(72) Inventors: Kouichirou MORI, Kawasaki Kanagawa (JP); Yu NASU, Meguro Tokyo (JP); Masatsune TAMURA, Kawasaki Kanagawa (JP); Masahiro MORITA, Yokohama Kanagawa (JP)

(21) Appl. No.: 14/474,591

(22) Filed: Sep. 2, 2014

(30) Foreign Application Priority Data
Sep. 17, 2013 (JP) 2013-192359

(51) Int. Cl. G10L 13/027

(52) U.S. Cl. CPC G10L 13/027
USPC 704/260

(57) ABSTRACT

According to an embodiment, a prosody editing device includes an approximate contour generator, a setter, a display controller, an operation receiver, and an updater. The approximate contour generator approximates a contour representing a time series of prosody information with a parametric curve including a control point to generate an approximate contour. The setter sets, on the approximate contour, an operation point corresponding to the control point. The display controller displays, on a display device, an operation screen including the approximate contour on which the operation point is shown. The operation receiver receives an operation to move the operation point optionally selected on the operation screen. The updater calculates a position of the control point from a moving amount of the operation point and updates the approximate contour.

### CROSS-REFERENCE TO RELATED APPLICATION(S)

This application is based upon and claims the benefit of priority from Japanese Patent Application No. 2013-192359, filed on Sep. 17, 2013; the entire contents of which are incorporated herein by reference.

### FIELD

Embodiments described herein relate generally to a prosody editing device and method and a computer program product.

### BACKGROUND

Recent speech synthesis technologies for generating a synthetic speech from a text use a statistical prosody model, thereby significantly improving the quality of the generated synthetic speech. Even if an elaborated prosody model is constructed from a large amount of speech corpus, however, average prosody generated from the prosody model may possibly be insufficient in the cases of colloquial expressions and word-ending expressions, such as greetings having various types of prosody. To address this, there has been proposed a device that edits prosody generated from a prosody model in response to a user operation.

Such a device that edits prosody in response to a user operation needs to provide natural prosody desired by the user with an intuitive and simple operation to prevent deterioration in the quality of a synthetic speech caused by unnaturalness of edited prosody and to improve user operability in the editing work.

### BRIEF DESCRIPTION OF THE DRAWINGS

FIG. 1 is a block diagram of an exemplary configuration of a prosody editing device according to an embodiment;

FIG. 2 is a view of an example of a cubic Bézier curve;

FIG. 3 is a schematic of an example of an approximate contour;

FIGS. 4A and 4B are schematics of a state where operation points are set on the approximate contour;

FIG. 5 is a schematic of an example of an operation screen displayed on a display device;

FIG. 6 is a schematic of a state where the approximate contour is updated in response to an operation to move an operation point;

FIG. 7 is a schematic of an example of the updated operation screen;

FIG. 8 is a flowchart of a series of processing performed by the prosody editing device according to the embodiment;

FIG. 9 is a flowchart illustrating editing in detail;

FIG. 10 is a schematic of a state where an operation point is added at a desired position on the approximate contour; and

FIG. 11 is a block diagram of an exemplary hardware configuration of the prosody editing device according to the embodiment.

### DETAILED DESCRIPTION

According to an embodiment, a prosody editing device includes an approximate contour generator, a setter, a display controller, an operation receiver, and an updater. The approximate contour generator approximates a contour representing a time series of prosody information with a parametric curve including a control point to generate an approximate contour. The setter sets, on the approximate contour, an operation point corresponding to the control point. The display controller displays, on a display device, an operation screen including the approximate contour on which the operation point is shown. The operation receiver receives an operation to move the operation point optionally selected on the operation screen. The updater calculates a position of the control point from a moving amount of the operation point and updates the approximate contour.

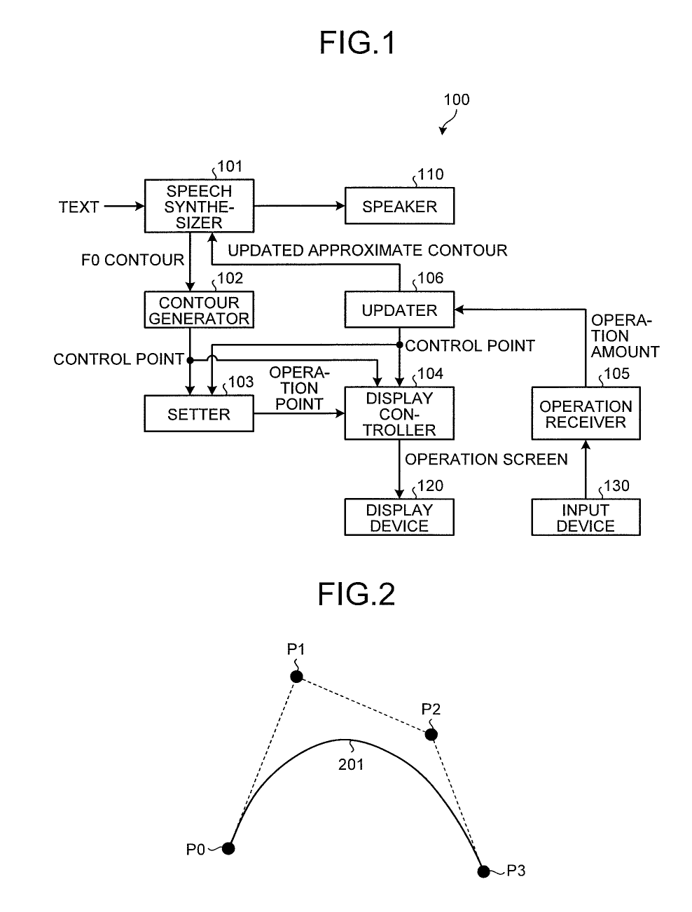

FIG. 1 is a block diagram of an exemplary configuration of a prosody editing device 100 according to an embodiment. As illustrated in FIG. 1, the prosody editing device 100 includes a speech synthesizer 101, an approximate contour generator 102, a setter 103, a display controller 104, an operation receiver 105, and an updater 106. The prosody editing device 100 further includes a speaker 110, a display device 120, such as a liquid-crystal display, and an input device 130, such as a mouse and a touch panel, as user interfaces. In the case where a touch panel is used as the input device 130, the display device 120 and the input device 130 are integrated.

The speech synthesizer 101 receives a text from the outside to generate prosody and a synthetic speech. To generate prosody, a statistical prosody model is used, for example. As for a speech synthesis method, a desired method may be employed, including publicly known unit selection speech synthesis and Hidden Markov Model speech synthesis. The speech synthesizer 101 may also receive prosody edited by a user operation (an updated approximate contour, which will be described later), thereby generating a synthetic speech to which the edited prosody is applied. The synthetic speech generated by the speech synthesizer 101 is output from the speaker 110.

Examples of prosody information (parameters capable of being handled by a calculator) indicating prosody of a speech include a fundamental frequency (F0), and duration and power of a phoneme. A time series of F0 can be represented by a line, where an abscissa represents time and an ordinate represents the frequency. The time series of F0 represented by such a line is referred to as an F0 contour. Editing the F0 contour makes it possible to generate a synthetic speech having various types of intonation.

The following describes a case where an F0 contour generated by the speech synthesizer 101 is a target to be edited. However, the prosody information to be edited is not limited to an F0 contour. The prosody editing method according to the present embodiment is widely applicable to any time series of prosody information capable of being represented by a line (a contour). A time series of duration of a phoneme, for example, can be represented by a line (a contour), where an abscissa represents generation time of the phoneme and an ordinate represents the time length. A time series of power can be represented by a line (a contour), where an abscissa represents time and an ordinate represents the magnitude of the power. The present embodiment is also applicable to editing of the time series of duration of a phoneme and the time series of power.

The approximate contour generator 102 approximates the F0 contour generated by the speech synthesizer 101 with a parametric curve in a predetermined unit, thereby generating an approximate contour. Examples of the parametric curve include a spline curve, a B-spline curve, and a Bézier curve. The present embodiment uses a Bézier curve as the parametric curve to generate an approximate contour. The parametric curve used for approximation is not limited to a Bézier curve.

The Bézier curve is the (N−1)th order parametric curve defined by N control points. Because the Bézier curve can express a continuous curve with a small number of parameters, the Bézier curve is frequently used to draw a smooth curve. The equation of the m-th order Bézier curve is expressed by the following equation (1):

$$q ( {t}_{i} ) = {\sum }_{k = 0}^{m} ( \begin{matrix}m \\ k\end{matrix} ) {{P}_{k} ( 1 - {t}_{i} )}^{m - k} {t}_{i}^{k} 0 \leq {t}_{i} \leq 1 \qquad ( 1 )$$

where m represents an order of the Bézier curve, ti represents a parameter, i represents an index of the parameter, and Pk represents coordinates of the k-th control point on a two-dimensional coordinate plane. The parameter ti varies from 0 to 1, thereby constructing one Bézier curve.

The shape of the m-th order Bézier curve is uniquely determined by a set of m+1 control points (P0, P1, P2, . . . , Pm). The equation of a cubic Bézier curve, for example, is defined by the following equation (2):

q(tᵢ)=(1−tᵢ)³P₀+3tᵢ(1−tᵢ)²P₁+3tᵢ²(1−tᵢ)P₂+tᵢ³P₃ (2)

FIG. 2 is a view of an example of a cubic Bézier curve. A cubic Bézier curve 201 illustrated in FIG. 2 is defined by four control points P0, P1, P2, and P3. P0 and P3 are control points serving as end points of the Bézier curve 201. Typically, control points other than the end points are not necessarily present on the Bézier curve 201.

The approximate contour generator 102 segments the F0 contour generated by the speech synthesizer 101 in a predetermined unit and approximates each segment with a Bézier curve, thereby generating an approximate contour. The present embodiment uses the least-squares method to calculate the control points of the Bézier curve with which each segment of the F0 contour is approximated. While the explanation will be made of an example of approximation with a cubic Bézier curve to simplify the explanation, an approximation with an m-th order Bézier curve other than a cubic Bézier curve may be generalized by a similar way.

The approximate contour generator 102 estimates the control point Pk that minimizes the sum of square errors defined by the following Equation (3), where pi (i=1 to n) represents coordinates of a certain segment of the F0 contour on the two-dimensional coordinate plane, and q(ti) represents the Bézier curve. In this equation, n represents the number of data of the parameter t.

$$S = {\sum }_{i = 1}^{n} {[ {p}_{i} - q ( {t}_{i} ) ]}^{2} \qquad ( 3 )$$

With the least-squares method, the coordinate Pk of the control point is eventually calculated by the following equations (4) and (5). Because P0 and P3 correspond to the end points of the Bézier curve, the coordinates of these points are equal to those of pl and pn serving as end points of the certain segment of the F0 contour. Constants in equations (4) and (5) are defined by the following equations (6) to (10).

$$\begin{matrix}{P}_{1} = \frac{{A}_{2} {C}_{1} - {A}_{12} {C}_{2}}{{A}_{1} {A}_{2} - {A}_{12} {A}_{12}} & ( 4 ) \\ {P}_{2} = \frac{{A}_{1} {C}_{2} - {A}_{12} {C}_{1}}{{A}_{1} {A}_{2} - {A}_{12} {A}_{12}} & ( 5 ) \\ {A}_{1} = 9 {\sum }_{i = 1}^{n} {{t}_{i}^{2} ( 1 - {t}_{i} )}^{4} & ( 6 ) \\ {A}_{2} = 9 {\sum }_{i = 1}^{n} {{t}_{i}^{4} ( 1 - {t}_{i} )}^{2} & ( 7 ) \\ {A}_{12} = 9 {\sum }_{i = 1}^{n} {{t}_{i}^{3} ( 1 - {t}_{i} )}^{3} & ( 8 ) \\ {C}_{1} = {\sum }_{i = 1}^{n} 3 {{t}_{i} ( 1 - {t}_{i} )}^{2} [ {p}_{i} - {( 1 - {t}_{i} )}^{3} {P}_{0} - {t}_{i}^{3} {P}_{3} ] & ( 9 ) \\ {C}_{2} = {\sum }_{i = 1}^{n} 3 {t}_{i}^{2} ( 1 - {t}_{i} ) [ {p}_{i} - {( 1 - {t}_{i} )}^{3} {P}_{0} - {t}_{i}^{3} {P}_{3} ] & ( 10 )\end{matrix}$$

In this way, the control points of the Bézier curve with which each segment of the F0 contour is approximated are calculated. A curve obtained by connecting the Bézier curves of the segments in chronological order corresponds to an approximate contour. The present embodiment performs editing considering the approximate contour as the F0 contour.

In the present embodiment, it is assumed that an input text is written in Japanese and that the predetermined unit in which the F0 contour is segmented is an accentual phrase unit. In other words, the F0 contour is approximated with the Bézier curve in each accentual phrase. In this case, the order of the Bézier curve with which a segment of the F0 contour is approximated is preferably set to a value equal to or larger than the number of morae included in the accentual phrase of the segment. This can reduce an approximation error of the approximate contour (Bézier curve) with respect to the F0 contour. The predetermined unit in which the F0 contour is segmented is not limited to an accentual phrase. Any desired unit that prevents the approximation error from increasing may be employed.

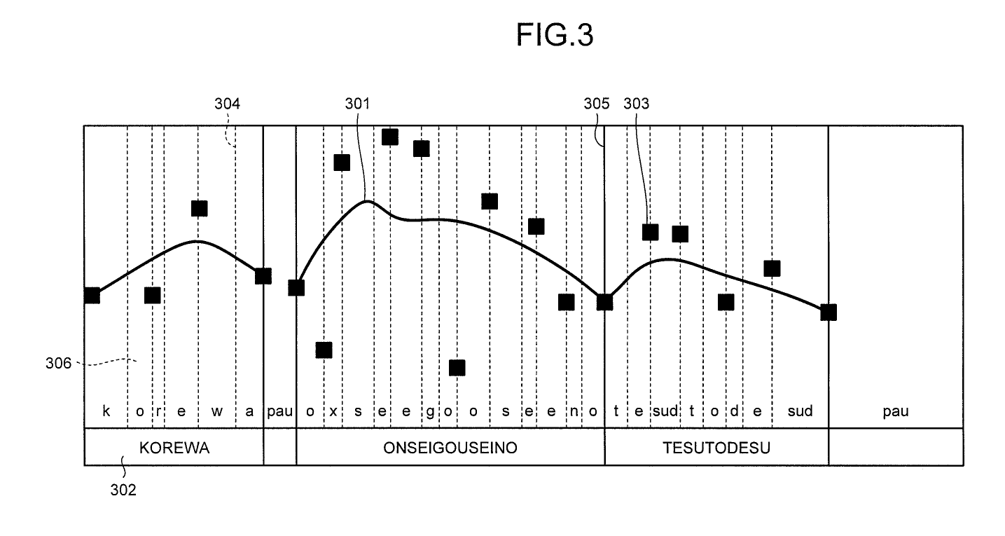

FIG. 3 is a schematic of an example of the approximate contour generated by the approximate contour generator 102. An approximate contour 301 illustrated in FIG. 3 is obtained by approximating an F0 contour of an input text 302 with the Bézier curve in each accentual phrase, for example. The input text 302 is composed of three accentual phrases (excluding a pause) of “KOREWA/ ONSEIGOUSEINO/ TESUTODESU” (in English, “this is speech synthesis test”). The horizontal direction in FIG. 3 corresponds to a time axis (hereinafter, referred to as an X-axis), whereas the vertical direction corresponds to a frequency axis (hereinafter, referred to as a Y-axis). The filled squares in FIG. 3 are control points 303 of the Bézier curve. Vertical dashed lines 304 indicate boundaries between phonemes in the X-axis, whereas vertical solid lines 305 indicate boundaries between accentual phrases in the X-axis. A string such as “k/o/r/e/w/a” above the input text 302 is a phoneme string 306. The approximate contour generator 102 estimates the coordinates of the control points 303 in each accentual phrase and connects the Bézier curves defined by the control points 303 (excluding a pause), thereby generating the approximate contour 301.

The setter 103 sets, on the approximate contour, operation points corresponding to the control points of the Bézier curve with which the F0 contour is approximated (that is, on the Bézier curve). The operation point is operated by the user on an operation screen, which will be described later, to edit the F0 contour using the approximate contour and is always present on the approximate contour. The control points of the Bézier curve and the operation points on the approximate contour make a pair and are in one-to-one correspondence. Setting the operation points means storing the coordinates of the operation points.

As described above, the control points other than the end points of the Bézier curve are not necessarily present on the Bézier curve. In the present embodiment, the operation points corresponding to the control points of the Bézier curve are set on the approximate contour. This enables the user to edit the F0 contour (approximate contour) by operating the operation points on the approximate contour. The user can operate the operation points present on the approximate contour more intuitively than the control points not present on the approximate contour. The control points serving as the end points of the Bézier curve may be set as the operation points.

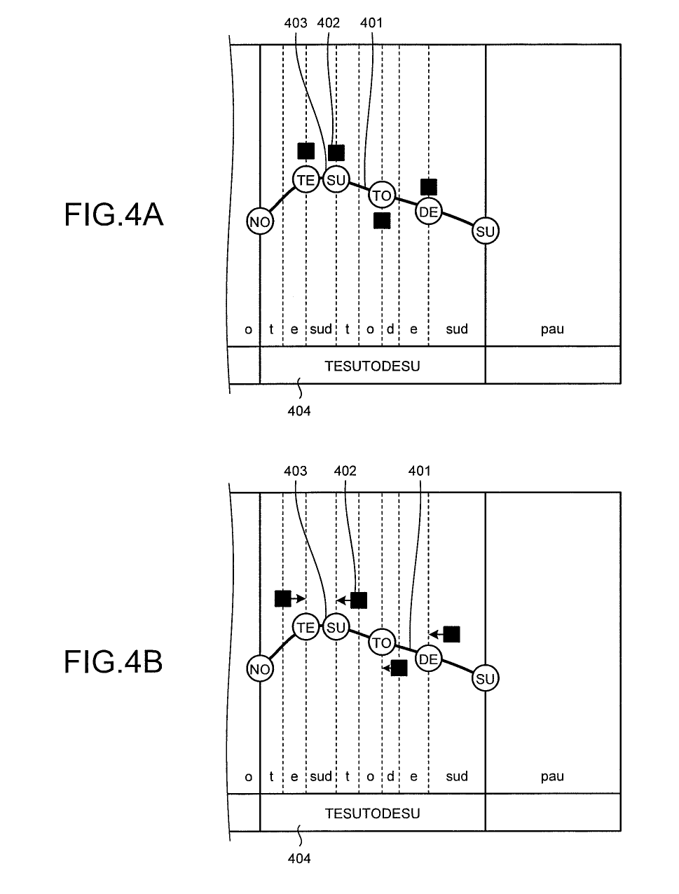

FIGS. 4A and 4B are schematics of a state where operation points are set on the approximate contour. The example in FIGS. 4A and 4B illustrates a part of the approximate contour 301 illustrated in FIG. 3 (a part corresponding to the accentual phrase “test”) as an approximate contour 401. The filled squares represent control points 402 of the Bézier curve forming the approximate contour 401 in the same manner as in FIG. 3. The open circles represent operation points 403 corresponding to the control points 402. Because the control points serving as the end points of the Bézier curve are present on the approximate contour 401, the control points themselves serve as the operation points.

In the example illustrated in FIGS. 4A and 4B, the number of the control points 402 is set equal to the number of morae in an input text 404, and thus the morae each have one operation point 403. Characters in the open circles representing the operation points 403 in FIGS. 4A and 4B indicate the morae corresponding to the respective operation points 403. The number of control points 402 and the number of operation points 403 corresponding thereto are not necessarily equal to the number of morae in the input text 404. The control points 402 and the operation points 403 may be provided to respective phonemes in the input text 404 or may be provided regardless of the morae and the phonemes, for example.

An assumption is made that the X-coordinates of the control points 402 coincide with those of the morae as illustrated in FIG. 4A. In this case, by projecting the control points 402 vertically (in the Y-axis direction) onto the approximate contour 401, the operation points 403 corresponding to the respective control points 402 can be set on the approximate contour 401. As illustrated in FIG. 4B, however, the X-coordinates of the control points 402 calculated by equations (4) and (5) given above do not necessarily coincide with the X-coordinates of the respective morae. In this case, the positions of the control points 402 are adjusted such that the X-coordinates of the control points 402 coincide with those of the morae. As indicated by the arrows in FIG. 4B, for example, the control points 402 are parallel translated such that the X-coordinates of the control points 402 coincide with those of the morae.

The translation of the control points 402 slightly changes the shape of the Bézier curve. This may possibly increase an error (an approximation error) between the Bézier curve and the original F0 contour. In the case where the approximation error exceeds a threshold, the control points 402 may be projected directly vertically (in the Y-axis direction) onto the approximate contour 401 without being parallel translated, thereby setting the operation points 403. More sophisticatedly, a constrained least-squares method may be used to approximate the F0 contour with the Bézier curve. The constrained least-squares method has constraint that causes the X-coordinates of the control points 402 to coincide with the X-coordinates of the morae, thereby minimizing the approximation error. Alternatively, another operation point 403 may be added at a generation position of a mora on the approximate contour 401 using a function of adding another operation point in response to a user operation (which will be described later as a modification).

The display controller 104 displays an operation screen including the approximate contour on which the operation points are shown on the display device 120.

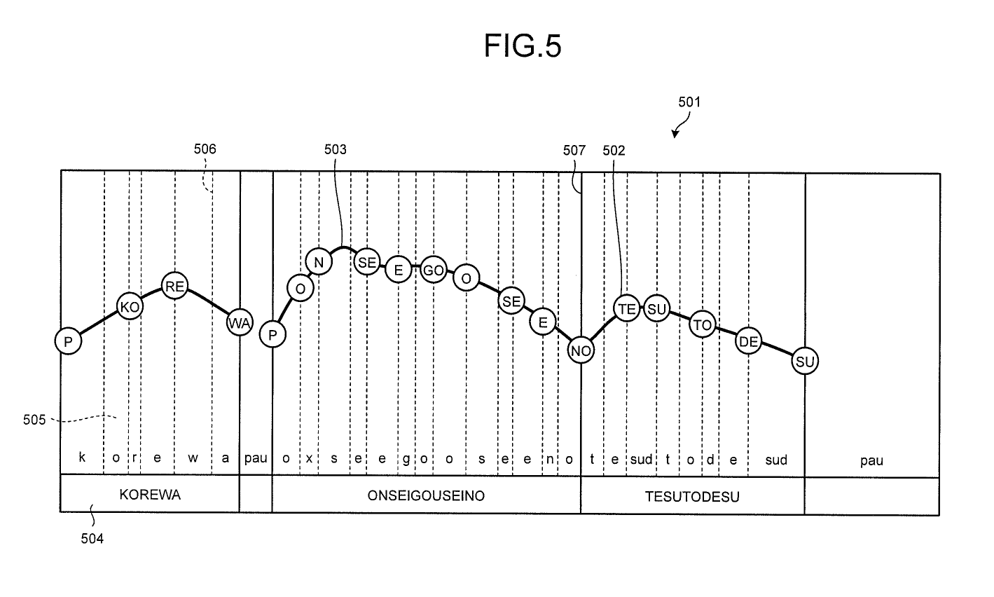

FIG. 5 is a schematic of an example of the operation screen displayed on the display device 120 under the control of the display controller 104. In an operation screen 501 illustrated in FIG. 5, the horizontal direction of the screen corresponds to the X-axis, whereas the vertical direction corresponds to the Y-axis. The operation screen 501 includes an approximate contour 503 on which operation points 502 are shown. Similarly to the approximate contour 301 illustrated in FIG. 3, the approximate contour 503 is obtained by approximating an F0 contour of an input text 504 of “KOREWA/ ONSEIGOUSEINO/TESUTODESU” with the Bézier curve in each accentual phrase. Similarly to the example illustrated in FIGS. 4A and 4B, the operation points 502 on the approximate contour 503 are represented by the open circles, and notations of morae corresponding to the operation points 502 are written in the respective open circles. In the case where the operation points 502 are set for respective phonemes, notations of the phonemes may be written in the open circles instead of the notations of the morae.

Similarly to the example in FIG. 3, the operation screen 501 illustrated in FIG. 5 displays the input text 504 and a phoneme string 505 together with the approximate contour 503. Vertical dashed lines 506 represent boundaries between phonemes, whereas vertical solid lines 507 represent boundaries between accentual phrases. The control points are not necessarily displayed on the operation screen 501 but may be displayed as a guide.

The user performs an operation to move a desired operation point 502 in the Y-axis direction on the operation screen 501 illustrated in FIG. 5 with the input device 130, thereby editing the F0 contour. In the case where a mouse is used as the input device 130, for example, the user performs a drag-and-drop operation on the desired operation point 502, thereby moving the operation point 502 in the Y-axis direction. In the case where a touch panel is used as the input device 130, the user performs a touch operation on the desired operation point 502, thereby moving the operation point 502 in the Y-axis direction.

The format of the operation screen displayed on the display device 120 is not limited to that illustrated in FIG. 5. The operation screen displayed on the display device 120 simply needs to include an approximate contour on which operation points that can be moved by an operation of the user are shown.

The operation receiver 105 receives the user operation to move the desired operation point on the operation screen displayed on the display device 120 and transmits the moving amount of the operation point to the updater 106.

The updater 106 calculates the position of a control point corresponding to the moved operation point from the moving amount of the operation point received from the operation receiver 105 and updates the approximate contour. The updated approximate contour corresponds to an edited F0 contour.

The operation points on the approximate contour are in one-to-one correspondence with the control points of the Bézier curve forming the approximate contour. As an operation point moves, a control point corresponding thereto also moves. Because the moving amount of the operation point is not equal to that of the control point, it is necessary to calculate the position (coordinates) of the control point from the moving amount of the operation point by making a calculation below.

To simplify the calculation, two assumptions are made. The first assumption is that the user is restricted to moving an operation point only in the vertical direction (Y-axis direction). The second assumption is that the coordinates of control points other than the control point corresponding to the operation point moved by the user are constant. Introduction of the two assumptions facilitates calculation of the moving amount of the control point corresponding to the operation point from the moving amount of the operation point on the approximate contour as follows.

P2 represents the control point corresponding to the moved operation point, for example. Given t represents a value of the parameter at the position of the operation point corresponding to the control point P2, Δq represents a moving amount of the operation point in the vertical direction, and ΔP represents a moving amount of the control point P2 in the vertical direction, the following equation (11) is satisfied:

q(t)+Δq=(1−t)³P₀+3t(1−t)²P₁+3t²(1−t)(P₂+ΔP)+t³P₃ (11)

By substituting q(t) of equation (2) given above into equation (11) and organizing the equation, the following equation (12) is obtained:

$$Δ P = \frac{Δ q}{3 {t}^{2} ( 1 - t )} \qquad ( 12 )$$

With equation (12), it is possible to derive the moving amount ΔP of the control point from the moving amount Δq of the known operation point. By adding ΔP to the Y-coordinate of the control point P2 and then performing update, the coordinates of a new control point P2 can be obtained. By deriving the moving amount of a control point from that of a desired operation point in the same manner, the position of a new control point can be obtained.

The updater 106 obtains the position of the control point from the moving amount of the operation point by the calculation described above. The updater 106 redraws the Bézier curve using the new control point, thereby updating the approximate contour.

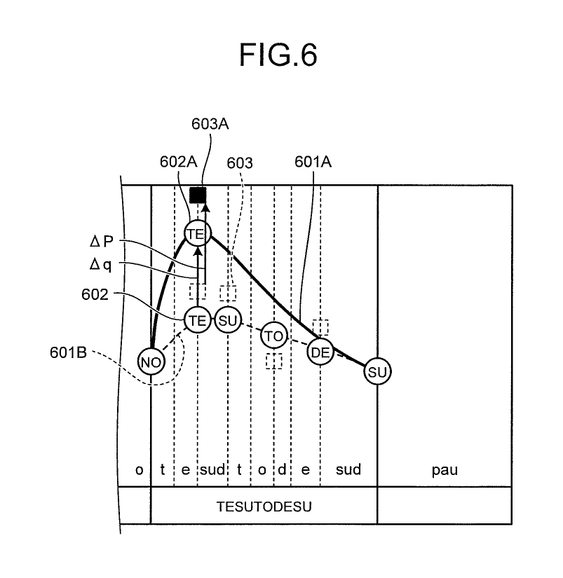

FIG. 6 is a schematic of a state where the approximate contour is updated in response to a user operation to move an operation point. In FIG. 6, the user moves an operation point corresponding to a mora “te” in the vertical direction on the operation screen 501 illustrated in FIG. 5, for example. In FIG. 6, the dashed curve indicates an approximate contour 601B before update, whereas the solid curve indicates an updated approximate contour 601A. Operation points 602 are represented by the open circles, control points 603 of the Bézier curve forming the approximate contour 601B before update are represented by the dashed squares, and a control point 603A corresponding to a moved operation point 602A is represented by the filled square. Because the control points serving as the end points of the Bézier curve are present on the approximate contour 601A (601B), the control points themselves serve as the operation points.

As illustrated in FIG. 6, the updater 106 makes the calculation described above, thereby obtaining the moving amount ΔP of the control point 603 based on the moving amount Δq of the operation point 602 corresponding to the more “te”. The updater 106 adds ΔP to the Y-coordinate of the control point 603 before being moved, thereby obtaining the position of the new control point 603A corresponding to the moved operation point 602A. The updater 106 draws another Bézier curve using the new control point 603A and the control points 603 corresponding to the other operation points 602 that are not moved, thereby updating the approximate contour 601B to the approximate contour 601A.

After the updater 106 updates the approximate contour, the speech synthesizer 101 receives the updated approximate contour as another F0 contour and generates a synthetic speech using the F0 contour. The synthetic speech is then output from the speaker 110. The user listens to the synthetic speech output from the speaker 110, thereby checking the effects of the editing.

After the updater 106 updates the approximate contour, the setter 103 newly sets operation points on the updated approximate contour. The display controller 104 displays, on the display device 120, an operation screen including the updated approximate contour on which the newly set operation points are shown. Thus, the operation screen displayed on the display device 120 is updated. The user can perform the editing work further on the updated operation screen.

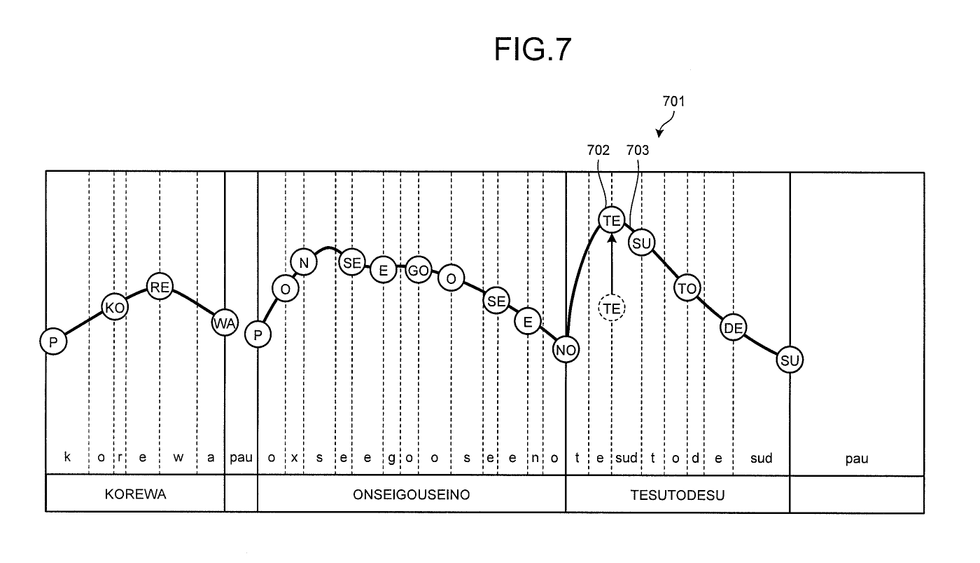

FIG. 7 is a schematic of an example of the updated operation screen. An operation screen 701 illustrated in FIG. 7 is an operation screen updated in response to a user operation to move the operation point corresponding to the mora “te” as illustrated in FIG. 6 on the operation screen 501 illustrated in FIG. 5. As is clear from the comparison between the operation screen 701 in FIG. 7 and the operation screen 501 in FIG. 5, in response to a user operation to move an operation point 702 corresponding to the mora “te”, an approximate contour 703 changes over the entire segment of the accentual phrase “test” including the mora “te”. Subsequently, operation points 702 are newly set at positions corresponding to the respective morae on the updated approximate contour 703. As for the morae other than the mora “te” of which the operation point 702 is moved by the user, the positions of the operation points 702 corresponding thereto change, but the positions of the control points corresponding thereto do not change.

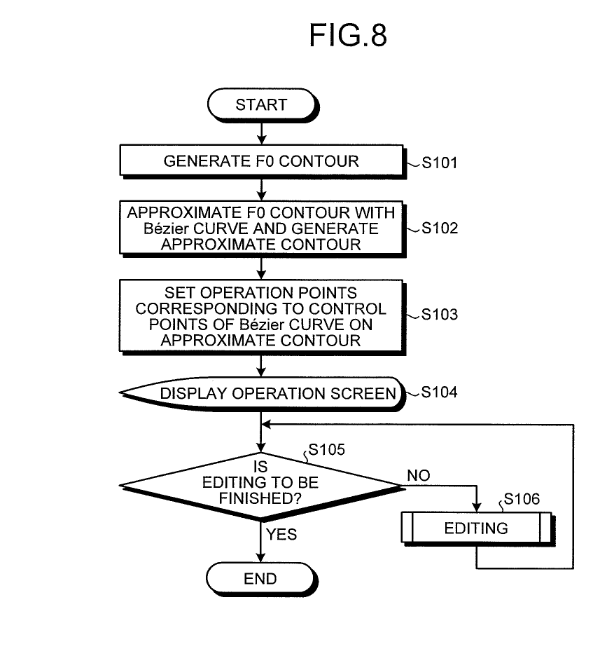

The following described an operation of the prosody editing device 100 according to the present embodiment. FIG. 8 is a flowchart of a series of processing performed by the prosody editing device 100.

First, the speech synthesizer 101 uses a statistical prosody model created in advance, for example, to generate an F0 contour of an input text (Step S101).

Subsequently, the approximate contour generator 102 approximates the F0 contour generated at Step S101 with a Bézier curve in a predetermined unit such as an accentual phrase, thereby generating an approximate contour (Step S102).

Subsequently, the setter 103 sets, on the approximate contour generated at Step S102, operation points corresponding to control points of the Bézier curve with which the F0 contour is approximated (Step S103).

Subsequently, the display controller 104 displays an operation screen including the approximate contour on which the operation points set at Step S103 are shown on the display device 120 (Step S104). The user uses the operation screen displayed on the display device 120 to perform an editing work to edit the F0 contour.

The prosody editing device 100 according to the present embodiment inquires of the user whether to finish the editing work as needed (Step S105). If the user issues no instruction to finish the editing work (No at Step S105), editing at Step S106 is repeated. If the user issues an instruction to finish the editing work (Yes at Step S105), the series of processes is ended.

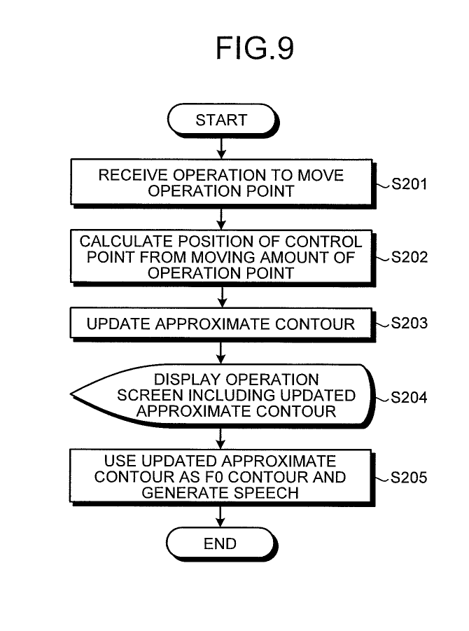

FIG. 9 is a flowchart illustrating the editing at Step S106 in FIG. 8 in detail.

First, the user performs an operation to move a desired operation point on the operation screen displayed on the display device 120 with the input device 130. The operation receiver 105 receives the operation of the user and transmits the moving amount of the operation point to the updater 106 (Step S201).

Subsequently, the updater 106 calculates the position of a new control point corresponding to the moved operation point from the moving amount of the operation point with the method described above (Step S202). The updater 106 then uses the new control point derived at Step S202 to update the approximate contour (Step S203).

Subsequently, the display controller 104 displays another operation screen including the approximate contour updated at Step S203 on the display device 120, thereby updating the operation screen displayed on the display device 120 (Step S204). Displayed on the updated operation screen is the updated approximate contour on which new operation points are shown.

The approximate contour updated at Step S203 is transmitted to the speech synthesizer 101 as an edited F0 contour. The speech synthesizer 101 uses the edited F0 contour to generate a synthetic speech, and the synthetic speech is then output from the speaker 110 (Step S205). The user listens to the synthetic speech, thereby checking whether desired prosody is obtained. To further perform the editing work, the user performs an operation to move a desired operation point on the operation screen updated at Step S204. To finish the editing work, the user issues an instruction to finish the work.

As described in detail with the specific example, the prosody editing device 100 according to the present embodiment approximates a contour representing a time series of prosody information with a parametric curve, thereby generating an approximate contour. The prosody editing device 100 sets operation points corresponding to control points of the parametric curve on the approximate contour. The prosody editing device 100 displays, on the operation screen, an operation screen including the approximate contour on which the operation points are shown, and updates the approximate contour in response to a user operation to move an operation point. The prosody editing device 100 according to the present embodiment edits prosody in this manner and thus can provide natural prosody desired by the user with an intuitive and simple operation.

In other words, the prosody editing device 100 according to the present embodiment approximates a contour representing a time series of prosody information with a parametric curve, thereby generating an approximate contour. The prosody editing device 100 regards the approximate contour as a contour to be edited and updates the approximate contour in response to a user operation performed on an operation point, thereby performing editing. With an operation to move an operation point, the prosody editing device 100 can provide a contour in which a periphery of the operation point besides the position of the operation point is smoothly changed. Thus, the prosody editing device 100 can provide natural prosody desired by the user with a simple operation.

The prosody editing device 100 according to the present embodiment sets, on the approximate contour, the operation points to be operated to edit the contour. This enables the user to edit the contour with an intuitive operation as if the user directly transforms the contour to be edited.

While a method for transforming a curve by moving control points is widely known, the control points are not necessarily present on the curve. Simply applying the method to a technology for editing prosody prevents the user from performing an intuitive operation. There has also been developed a method for providing an interface used for operation separately from a contour to be edited and transforming the contour in response to an operation through the interface. In this case too, the user cannot perform an intuitive operation as if the user directly transforms the contour to be edited. By contrast, in the present embodiment, the approximate contour is updated in response to an operation performed on an operation point on the approximate contour, thereby editing the contour. This enables the user to edit the contour with an intuitive operation as if the user directly transforms the contour to be edited. To achieve this, the prosody editing device 100 according to the present embodiment sets operation points corresponding to control points on an approximate contour and calculates a position of a new control point from a moving amount of an operation point, thereby updating the contour.

Furthermore, in the prosody editing device 100 according to the present embodiment, the speech synthesizer 101 uses the updated approximate contour to generate a synthetic speech, and the synthetic speech is then output from the speaker 110. This enables the user to check the effects of the editing while listening to the synthetic speech.

Furthermore, the prosody editing device 100 according to the present embodiment uses a Bézier curve in particular as a parametric curve with which a contour representing a time series of prosody information is approximated. As a result, the prosody editing device 100 can increase the accuracy of approximation and provide natural prosody. In other words, a Bézier curve among parametric curves can make a change similar to that in the contour representing a time series of prosody information. The prosody editing device 100 generates an approximate contour using a Bézier curve, thereby providing natural prosody.

Furthermore, in the case where the positions (X-coordinates) of the control points 402 in the time-axis direction are different from the generation positions (X-coordinates) of phonemes or morae on the approximate contour 401 as illustrated in FIG. 4B, the prosody editing device 100 according to the present embodiment makes an adjustment such that the X-coordinates of the control points 402 coincide with those of the phonemes or the morae and sets the operation points 403. This enables the user to perform an editing work as if the user directly operates a phoneme or a mora desired to be changed, resulting in a more intuitive operation.

Furthermore, as illustrated in FIG. 5, the prosody editing device 100 according to the present embodiment displays the operation screen 501 on the display device 120. The operation screen 501 shows the operation points 502 on the approximate contour 503 using the notations representing the phonemes or the morae. This enables the user to perform an editing work as if the user directly operates the phoneme or the mora desired to be changed, resulting in a more intuitive operation.

### MODIFICATION

In the embodiment above, the operation receiver 105 receives a user operation to move an operation point already set on the approximate contour included in the operation screen. The operation receiver 105 may receive an operation to add an operation point at a desired position on the approximate contour besides the operation to move an operation point already set.

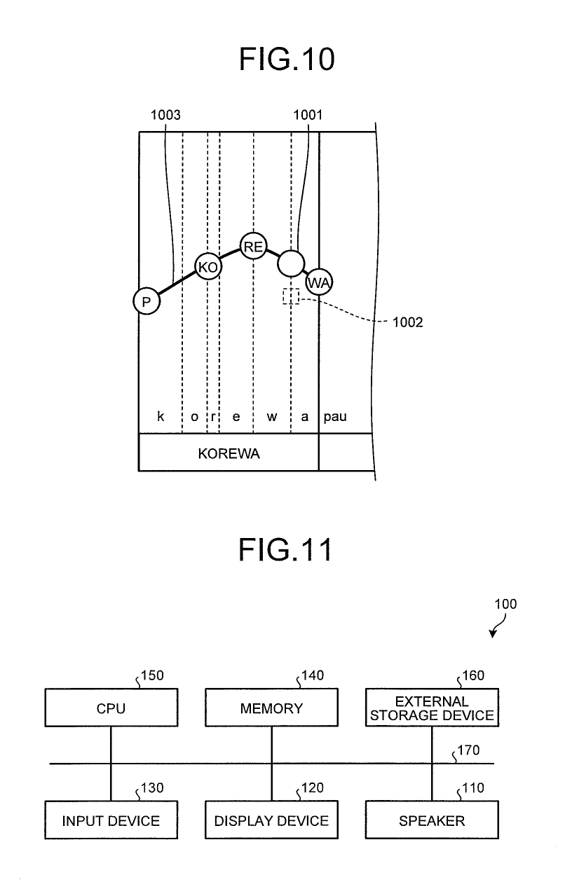

FIG. 10 is a schematic of a state where an operation point is added at a desired position on an approximate contour in response to a user operation. In the example in FIG. 10, the user performs an operation to add a new operation point 1001 at the position of the boundary between the phoneme “w” and the phoneme “a” on the approximate contour in the segment of the accentual phrase “KOREWA” on the operation screen 501 illustrated in FIG. 5.

The user performs an operation to add an operation point at a desired position on the approximate contour included in the operation screen with the input device 130. In the case where a mouse is used as the input device 130, for example, the user makes a double-click or a right-click with a cursor positioned at a desired position on the approximate contour, thereby adding an operation point at the position of the cursor. In the case where a touch panel is used as the input device 130, the user performs a touch operation on a desired position on the approximate contour, thereby adding an operation point at the touch position.

The operation receiver 105 receives the user operation to add an operation point at a desired position on the approximate contour and transmits position information (coordinates) of the added operation point to the updater 106.

The updater 106 obtains the position of a control point corresponding to the operation point by making a calculation below based on the position information of the operation point added by the user operation and updates the approximate contour.

Assuming that q represents the coordinates of the operation point added by the user operation, t represents a value of the parameter at the position, Pk represents the position of a control point corresponding to the added operation point, and the coordinates of control points other than the control point are constant, the following equation (13) is satisfied:

$$q - q ( t ) = ( \begin{matrix}m \\ k\end{matrix} ) {{P}_{k} ( 1 - t )}^{m - k} {t}^{k} \qquad ( 13 )$$

Equation (13) indicates that the term of the added control point Pk in the right side is equal to the change amount of the operation point in the left side. Thus, the coordinate Pk of the control point corresponding to the added operation point is calculated from the following equation (14):

$${P}_{k} = \frac{q - q ( t )}{( \begin{matrix}m \\ k\end{matrix} ) {( 1 - t )}^{m - k} {t}^{k}} \qquad ( 14 )$$

The updater 106 redraws the Bézier curve using the new control point thus calculated in this manner as well as the existing control points, thereby updating the approximate contour. In the example illustrated in FIG. 10, the dashed square represents a new control point 1002 corresponding to the added operation point 1001. The updater 106 uses the control point 1002 to provide an updated approximate contour 1003. The shape of the updated approximate contour 1003 does not significantly change with respect to the approximate contour to which the operation point is not yet added. Addition of the new control point 1002 increases the order, thereby making the shape of the approximate contour smoother.

After the approximate contour is updated, an operation screen including the updated approximate contour is displayed on the display device 120 similarly to the embodiment above. The user can edit the F0 contour in the same manner as in the embodiment above on the updated operation screen.

In this modification, an operation point can be added at a desired position on the approximate contour, thereby further improving user operability. In the case where the X-coordinates of the control points do not coincide with those of the phonemes or the morae on the approximate contour as described above, for example, operation points can be added at positions corresponding to the X-coordinates of the phonemes or the morae without making an adjustment to parallel translate the control points in the X-axis direction. This can reduce the approximation error.

The prosody editing device according to the present embodiment can be provided by using a general-purpose computer as basic hardware, for example. FIG. 11 is a block diagram of an exemplary hardware configuration of the prosody editing device 100 according to the present embodiment. In the example illustrated in FIG. 11, the prosody editing device 100 includes a memory 140, a central processing unit (CPU) 150, an external storage device 160, the speaker 110, the display device 120, the input device 130, and a bus 170. The memory 140 stores therein a computer program that performs prosody editing, for example. The CPU 150 controls each unit of the prosody editing device 100 in accordance with the computer program stored in the memory 140. The external storage device 160 stores therein various types of data required for control of the prosody editing device 100. The speaker 110 outputs a synthetic speech, for example. The display device 120 displays an operation screen. The input device 130 is used by the user to operate the operation screen. The bus 170 connects these units. The external storage device 160 may be connected to each unit via a wired or wireless local area network (LAN), for example.

Instructions on the processing described in the embodiment above are executed based on a computer program serving as software, for example. The instructions on the processing described in the embodiment above are recorded in a recording medium such as a magnetic disk (e.g., a flexible disk (FD) and a hard disk), an optical disc (e.g., a compact disc read only memory (CD-ROM), a compact disc recordable (CD-R), a compact disc rewritable (CD-RW), a digital versatile disc ROM (DVD-ROM), a DVD±R, a DVD±RW, and a Blu-ray (registered trademark) disc), a semiconductor memory, and the like as a computer-executable program. The recording medium may have any storage format as long as it is a computer-readable recording medium.

The computer reads the computer program from the recording medium and executes the instructions described in the computer program with the CPU 150 based on the computer program. Thus, the computer functions as the prosody editing device 100 according to the embodiment above. The computer may acquire or read the computer program via a network.

Based on the instructions of the computer program installed in the computer from the recording medium, an operating system (OS) operating on the computer and middleware (MW), such as database management software and a network, may perform a part of the processing to provide the present embodiment, for example.

The recording medium in the present embodiment is not limited to a medium independent of the computer and may be a recording medium that downloads and permanently or temporarily stores therein the computer program transmitted via a LAN, the Internet, or the like.

The recording medium is not limited to a single recording medium, and a plurality of media may perform the processing as the recording medium in the present embodiment. The recording media may have any configuration.

The computer program executed by the computer has a module configuration including the processing units constituting the prosody editing device 100 according to the present embodiment (the speech synthesizer 101, the approximate contour generator 102, the setter 103, the display controller 104, the operation receiver 105, and the updater 106). In an actual hardware configuration, the CPU 150 reads and executes the computer program from the memory 140 to load the processing units on the main memory, for example. Thus, the processing units are loaded and generated on the main memory.

The computer in the present embodiment performs the processing in the present embodiment based on the computer program stored in the recording medium. The computer may have any configuration, including a single device, such as a personal computer and a microcomputer, and a system in which a plurality of devices are connected via a network, for example. The computer in the present embodiment is not limited to a personal computer and may be an arithmetic processing unit included in an information processor and a microcomputer, for example. The computer collectively indicates equipment and devices capable of carrying out the functions in the present embodiment based on the computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A prosody editing device comprising:
an approximate contour generator to approximate a contour representing a time series of prosody information with a parametric curve including a control point to generate an approximate contour;
a setter to set, on the approximate contour, an operation point corresponding to the control point;
a display controller to display, on a display device, an operation screen including the approximate contour on which the operation point is shown;
an operation receiver to receive an operation to move the operation point optionally selected on the operation screen; and
an updater to calculate a position of the control point from a moving amount of the operation point and update the approximate contour.

2. The device according to claim 1, further comprising a speech synthesizer to generate a synthetic speech by using the approximate contour.

3. The device according to claim 1, wherein the approximate contour generator generates the approximate contour by using a Bézier curve as the parametric curve.

4. The device according to claim 1, wherein when a position of the control point in a time-axis direction is different from a generation position of a phoneme or a mora on the approximate contour, the setter makes an adjustment such that the position of the control point in the time-axis direction coincides with the generation position of the phoneme or the mora on the approximate contour and sets the operation point at the generation position of the phoneme or the mora on the approximate contour.

5. The device according to claim 4, wherein the display controller displays, on the display device, the operation screen including the approximate contour on which the operation point is shown with a notation representing the phoneme or the mora generated at the position of the operation point.

6. The device according to claim 1, wherein
the operation receiver further receives an operation to add the operation point at a desired position on the approximate contour included in the operation screen, and
when the operation point is added, the updater calculates, a position of the control point corresponding to the added operation point and updates the approximate contour.

7. A prosody editing method comprising:
approximating a contour representing a time series of prosody information with a parametric curve including a control point to generate an approximate contour;
setting, on the approximate contour, an operation point corresponding to the control point;
displaying on a display device, an operation screen including the approximate contour on which the operation point is shown;
receiving an operation to move the operation point optionally selected on the operation screen; and
calculating a position of the control point from a moving amount of the operation point and updating the approximate contour.

8. A computer program product comprising a computer-readable medium containing a computer program, the program causing a computer to execute:
approximating a contour representing a time series of prosody information with a parametric curve including a control point to generate an approximate contour;
setting, on the approximate contour, an operation point corresponding to the control point;
displaying, on a display device, an operation screen including the approximate contour on which the operation point is shown;
receiving an operation to move the operation point optionally selected on the operation screen; and
calculating a position of the control point from a moving amount of the operation point and updating the approximate contour.
